(19) United States
(12) Patent Application Publication
(10) Pub. No.: US 2014/0062901 A1
(43) Pub. Date: Mar. 6, 2014

(54) TOUCH PANEL

(71) Applicant: SAMSUNG ELECTRO-MECHANICS CO., LTD., Gyunggi-do (KR)

(72) Inventors: Seung Heon Han, Gyunggi-do (KR); Hee Soo Kim, Gyunggi-do (KR); Jung Eun Noh, Gyunggi-do (KR)

(73) Assignee: SAMSUNG ELECTRO-MECHANICS CO., LTD., Gyunggi-do (KR)

(21) Appl. No.: 13/663,306

(22) Filed: Oct. 29, 2012

(30) Foreign Application Priority Data
Aug. 29, 2012 (KR) 10-2012-0094826

(51) Int. Cl. G06F 3/041

(52) U.S. Cl. 345/173; 178/18.03

(57) ABSTRACT

Disclosed herein is a touch panel, including: an electrode formed in a pattern including rectangles arranged while sharing sides, the rectangle includes a first side and a second side which are parallel and a third side and a fourth side which are parallel, the first side being longer than the third side, and in the rectangles, among the rectangles, a first side of a first rectangle and a third side of a second rectangle form a straight angle, a first side of the third rectangle and a third side of a fourth rectangle form the straight angle, and a first side of the second rectangle and a fourth side of the third rectangle form the straight angle.

### CROSS REFERENCE TO RELATED APPLICATION

This application claims the benefit of Korean Patent Application No. 10-2012-0094826, filed on Aug. 29, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

With the development of a computer using digital technologies, auxiliary devices have also been developed together, and personal computers, portable transmitting apparatuses, other personal information processing apparatuses, and the like perform text and graphic processing by using various input devices such as a keyboard and a mouse.

However, with the rapid progress of an information-oriented society, purposes of the computer tend to be gradually extended. Therefore, it is difficult to efficiently drive a product by only the keyboard and the mouse that serve as the input devices at present. Accordingly, the necessity of an apparatus to be simple and less misoperated, and for anybody else to easily input information has been increased.

Further, in the case of a technology associated with the input device, a concern is changed to high reliability, durability, innovativeness, design and processing associated technologies over a level to satisfy a general function and in order to achieve the object, a touch panel is developed as an input device which is possible to input information such as texts, graphics, and the like.

The touch panel is a tool that is installed on a display surface of flat panel display devices such as a liquid crystal display device (LCD), a plasma display panel (PDP), and an electroluminescence (El) and an image display device such as a cathode ray tube (CRT), and is used for a user to select desired information while viewing the image display device.

Meanwhile, types of the touch panels include a resistive type, a capacitive type, an electro-magnetic type, a surface acoustic wave (SAW) type, and an infrared type. Various types of touch panels are adopted in electronic products by considering a problem in signal amplification, a difference in resolution, a difficulty in design and processing technology, an optical characteristic, an electrical characteristic, a mechanical characteristic, an environment resistant characteristic, an input characteristic, durability, and economics, and the types used in the widest ranges at present include the resistive type touch panel and the capacitive type touch panel.

Meanwhile, in the touch panel, a research of forming an electrode panel by using metal has been actively progressed as disclosed in Korean Patent Application Laid-Open No. 10-2010-0091497. As such, when the electrode is made of metal, electrical conductivity is excellent, and a demand and a supply are smooth. However, when the electrode is made of metal, the touch panel needs to be formed in a mesh structure by the unit of micrometer (μm) in order to prevent the user from recognizing the electrode made of metal. However, when the electrode of the touch panel is formed in a mesh structure which is regular and has a predetermined interval, since a periodic characteristic between an electrode pattern of the touch panel and a black matrix pattern of a color filter provided in the image display device (LCD, and the like) is overlapped, a Moire phenomenon occurs, and as a result, visibility deteriorates.

### SUMMARY OF THE INVENTION

The present invention has been made in an effort to provide a touch panel that includes an electrode formed in a pattern having predetermined regularity, however, a pattern in which a continuous line is not formed even in any direction to prevent a Moire phenomenon from occurring.

According to a first preferred embodiment of the present invention, there is provided a touch panel, including an electrode formed in a pattern including rectangles arranged while sharing sides, wherein the rectangle includes a first side and a second side which are parallel and a third side and a fourth side which are parallel, the first side being longer than the third side, and in the rectangles, among the rectangles, a first side of a first rectangle and a third side of a second rectangle form a straight angle, a first side of the third rectangle and a third side of a fourth rectangle form the straight angle, and a first side of the second rectangle and a fourth side of the third rectangle form the straight angle.

A length ratio of a short side and a long side of the rectangle may be 1:2.

The touch panel may further include a transparent substrate with the electrode formed thereon.

The electrode may be formed by copper (Cu), aluminum (Al), gold (Au), silver (Ag), titanium (Ti), palladium (Pd), chrome (Cr), or combinations thereof.

The electrode may be formed by metallic silver formed by exposing/developing a silver salt emulsion layer.

According to a second preferred embodiment of the present invention, there is provided a touch panel, including: an electrode formed in a pattern including parallelograms arranged while sharing sides, wherein the parallelogram includes a first side and a second side which are parallel and a third side and a fourth side which are parallel, the first side being longer than the third side and the first side and the third side form an acute angle or an obtuse angle, and in the parallelograms included in the pattern, among the parallelograms, a first side of a first parallelogram and a third side of a second parallelogram form a straight angle, a first side of the third parallelogram and a third side of a fourth parallelogram form the straight angle, and a first side of the second parallelogram and a fourth side of the third parallelogram form the straight angle.

A length ratio of a short side and a long side of the parallelogram may be 1:2.

The touch panel may further include a transparent substrate with the electrode formed thereon.

The electrode may be formed by copper (Cu), aluminum (Al), gold (Au), silver (Ag), titanium (Ti), palladium (Pd), chrome (Cr), or combinations thereof.

The electrode may be formed by metallic silver formed by exposing/developing a silver salt emulsion layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view of a touch panel according to a first preferred embodiment of the present invention;

FIG. 2 is an enlarged diagram acquired by enlarging area A illustrated in FIG. 1;

FIG. 3 is an enlarged diagram acquired by enlarging area B illustrated in FIG. 1;

FIGS. 4 and 5 are plan views illustrating a state in which the black matrix pattern of the color filter is overlapped with the electrode pattern of FIG. 1;

FIG. 6 is a plan view of a touch panel according to a second preferred embodiment of the present invention;

FIG. 7 is an enlarged diagram acquired by enlarging area A illustrated in FIG. 6;

FIG. 8 is an enlarged diagram illustrating another example of parallelograms illustrated in FIG. 7; and

FIGS. 9 and 10 are plan views illustrating a state in which the black matrix pattern of the color filter is overlapped with the electrode pattern of FIG. 6.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

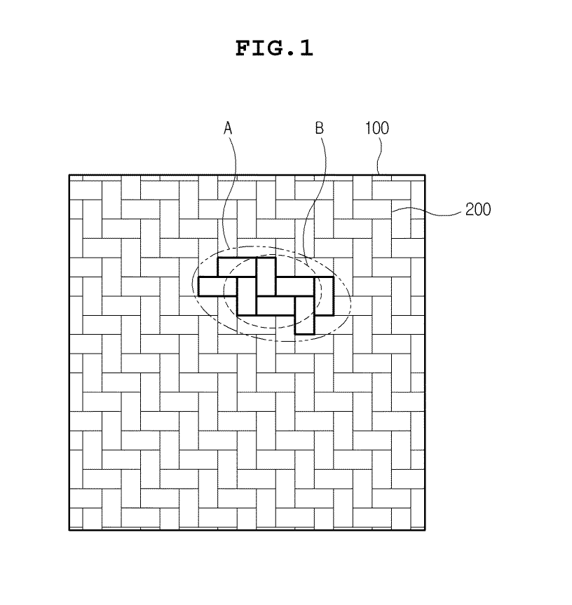

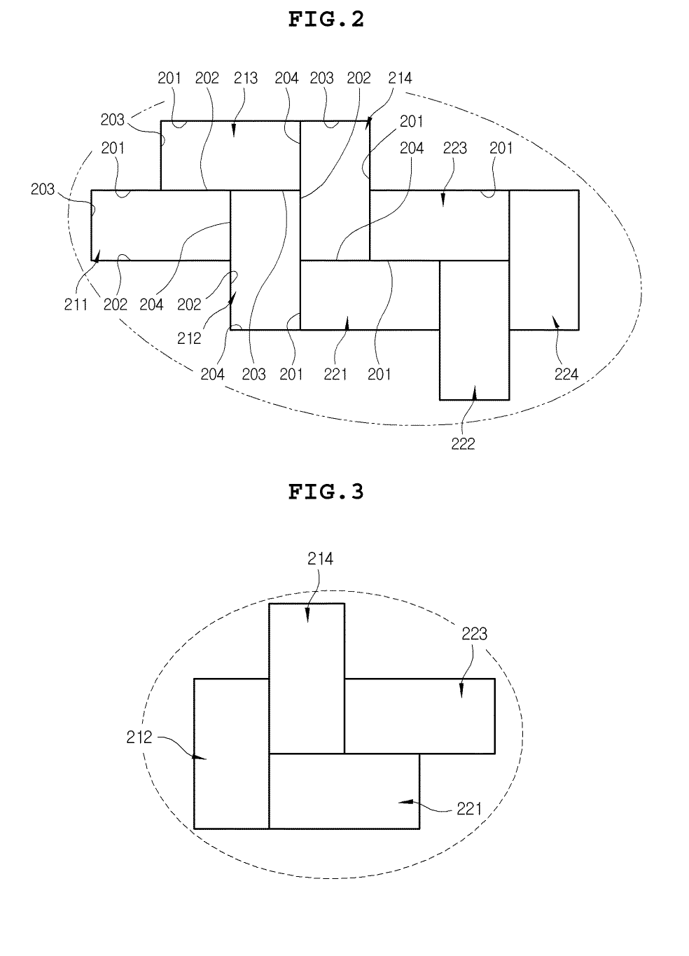

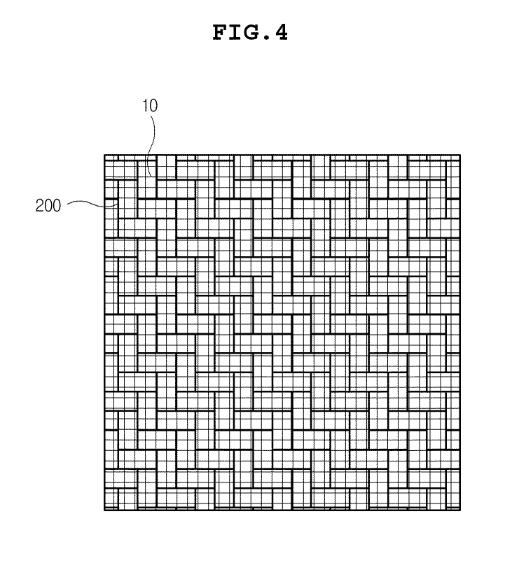

FIG. 1 is a plan view of a touch panel according to a first preferred embodiment of the present invention. FIG. 2 is an enlarged diagram acquired by enlarging area A illustrated in FIG. 1. FIG. 3 is an enlarged diagram acquired by enlarging area B illustrated in FIG. 1.

As illustrated in FIG. 1, the touch panel according to the preferred embodiment includes an electrode 200 formed in a pattern including rectangles that are arranged while sharing neighboring sides.

The electrode 200 serving to allow a controller to recognize a touch coordinate by generating a signal when the electrode 200 is touched by a user may be formed on a transparent substrate 100.

Herein, the electrode 200 may be formed by copper (Cu), aluminum (Al), gold (Au), silver (Ag), titanium (Ti), palladium (Pd), chrome (Cr), or combinations thereof. In this case, the electrode 200 may be formed by a plating process or an evaporation process using a sputter.

The electrode 200 may be formed by metallic silver formed by exposing/developing a silver salt emulsion layer in addition to the metal.

Meanwhile, the pattern forming the electrode 200 includes rectangles. Herein, the rectangle has two pairs of sides that are parallel to each other and any one pair of sides among them are longer than the other pair of sides. In order to describe the sides forming the rectangle in more detail, when the sides are described by using an example of the first rectangle 211 illustrated in FIG. 2, the first rectangle 211 includes a first side 201, a fourth side 204, a second side 202, and a third side 203 in a clockwise direction. The first side 201 and the second side 202 have the same length and are parallel to each other and it is the same even in the third side 203 and the fourth side 204. The any one pair of sides which are the longer becomes the first side 201 and the second side 202 in the example of the first rectangle 211 illustrated in FIG. 2. That is, the first side 201 is longer than the third side 203. An aspect ratio of the rectangle may be diversified. For example, a length ratio of a short side and a long side of the rectangle may be 1:2.

The pattern forming the electrode 200 includes a pattern in which the plurality of rectangles are arranged while sharing the sides with each other. In detail, the pattern of the electrode 200 may include rectangles (hereinafter, referred to as a ‘first rectangle group’) including the first rectangle 211, a second rectangle 212, a third rectangle 213, and a fourth rectangle 214.

In this case, in the first rectangle 211 and the second rectangle 212, the first side 201 of the first rectangle 211 and the third side 203 of the second rectangle 212 form a straight angle. Herein, the fact that two sides form the straight angle means that an angle between sides is 180° on the assumption that two sides are connected to each other. Hereinafter, it is also the same. Therefore, the first side 201 of the first rectangle 211 and the third side 203 of the second rectangle 212 form a straight line that extends on the same line. The first side 201 of the third rectangle 213 and the third side 203 of the fourth rectangle 214 also form the straight angle. The first side 201 of the third rectangle 213 and the third side 203 of the fourth rectangle 214 also form the straight line that extends on the same line.

Therefore, the first rectangle 211 and the second rectangle 212, and the third rectangle 213 and the fourth rectangle 214 have a pattern to be arranged to be perpendicular to each other.

In this case, the first side 201 of the second rectangle 212 and the fourth side 204 of the third rectangle 213 also form the straight angle. That is, the third rectangle 213 is arranged while sharing the side with the first rectangle 211 and the second rectangle 212 and in this case, the fourth side 204 of the third rectangle 213 and the first side 201 of the second rectangle 212 form the straight line that extends on the same line.

The pattern of the electrode 200 includes the first rectangle group including 211, 212, 213, and 214. Other rectangles having the same arrangement rule as the first rectangle group including 211, 212, 213, and 214 may be arranged continuously while sharing the sides with the first rectangle group including 211, 212, 213, and 214.

In detail, the pattern of the electrode 200 may be formed by arranging other rectangles (hereinafter, referred to as a ‘second rectangle group’) 221, 222, 223, and 224 including a fifth rectangle 221, a sixth rectangle 222, a seventh rectangle 223, and an eighth rectangle 224 having the same arrangement rule as the first rectangle group including 211, 212, 213, and 214, which are continuous with the first rectangle group including 211, 212, 213, and 214 as illustrated in FIG. 2. In this case, the second rectangle 212 shares the sides with the fifth rectangle 221 and the fourth rectangle 214 shares the sides with the fifth and seventh rectangles 221 and 223.

However, as described above, in order to discriminate the second rectangle group from the first rectangle group, the second rectangle group has been described separately from the first rectangle group. However, in the case of the second rectangle group, the fifth, sixth, seventh, and eighth rectangles 221, 222, 223, and 224 forming the second rectangle group may be rectangles corresponding to the first, second, third, and fourth rectangles 211, 212, 213, and 214 forming the first rectangle group, respectively.

Meanwhile, among the first to eighth rectangles 211, 212, 213, 214, 221, 222, 223, and 224, in rectangles (referred to as a ‘third rectangle group’) 212, 214, 221, and 223 including the second rectangle 212, the fourth rectangle 214, the fifth rectangle 221, and the seventh rectangle 223 illustrated in FIG. 3, an arrangement pattern thereof is the same as an arrangement pattern when the first rectangles 211, 212, 213, and 214 rotate 180°. The arrangement pattern is the same as an arrangement pattern when the second rectangles 221, 222, 223, and 224 rotate 180°. Therefore, the arrangement rule of the third rectangles 212, 214, 221, and 223 is also the same as the arrangement rules of the first rectangles 211, 212, 213, and 214 and the second rectangle groups 221, 222, 223, and 224.

In the case of only the third rectangle group, the seventh, fourth, fifth, and second rectangles 223, 214, 221, and 212 forming the third rectangle group may be rectangles corresponding to the first, second, third, and fourth rectangles 211, 212, 213, and 214 forming the first rectangle group.

As the pattern of the electrode 200 includes the rectangles, a continuous line is not formed even in any direction. In detail, as illustrated in FIG. 2, the third side 203 of the second rectangle 212 does not extend in a region of the fourth rectangle 214 any longer and the second side 202 of the second rectangle 212 does not also extend in a region of the third rectangle 213 any longer. The first side 201 of the fifth rectangle 221 and the first side 201 of the seventh rectangle 223 do not extend in a region of the second rectangle 212 and the region of the fourth rectangle 214 any longer.

Likewise, in the pattern of the electrode 200, the continuous line is not formed even in any direction of a horizontal direction and a vertical direction. On the contrary, the pattern of the black matrix of the color filter provided in the image display device (LCD, and the like) generally the line which is continuous in the horizontal direction and the vertical direction while forming a periodic lattice structure. Therefore, the periodic characteristics of the pattern of the electrode 200 and the pattern of the black matrix are not overlapped with each other, and as a result, the touch panel according to the preferred embodiment may prevent the Moire phenomenon from occurring.

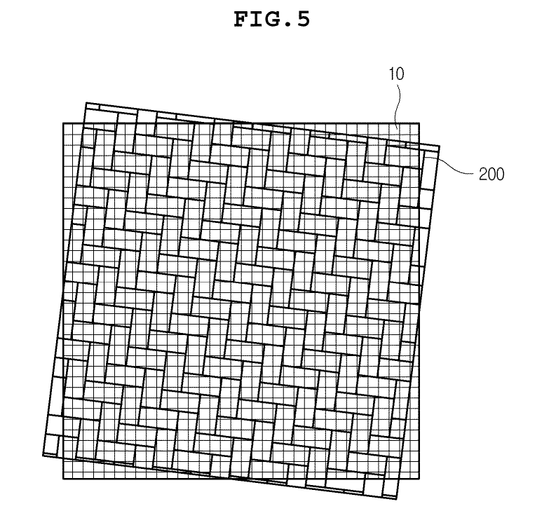

In more detail, referring to FIGS. 4 and 5, the case in which the Moire phenomenon does not occur will be described below.

FIGS. 4 and 5 are plan views illustrating a state in which the black matrix pattern of the color filter is overlapped with the electrode pattern of FIG. 1.

As illustrated in FIG. 4, the pattern of the electrode 200 does not have the line which is continuous in any direction. On the contrary, the pattern of the black matrix 10 of the color filter provided in the image display device (LCD, and the like) has a line which is continuous in the horizontal and vertical directions while forming the periodic lattice structure. Accordingly, although the pattern of the electrode 200 and the pattern of the black matrix 10 are overlapped with each other, occurrence of an interference phenomenon may be minimized, and as a result, the Moire phenomenon may be prevented.

As illustrated in FIG. 5, although the patterns are rotated at a predetermined angle while the pattern of the electrode 200 and the pattern of the black matrix 10 are overlapped with each other, an interference phenomenon may also be minimized, and as a result, the Moire phenomenon may be prevented.

Moreover, since the pattern of the electrode 200 may maintain an aperture ratio per unit area of the pattern of the electrode 200, the touch panel may ensure electrical conductivity and visuality.

Meanwhile, the electrode 200 may be formed on the transparent substrate 100 (see FIG. 1), and herein, the transparent substrate 100 needs to have support force to support the electrode 200 and transparency that allows a user to recognize an image provided in the image display device. By considering the support force and the transparency, the transparent substrate 100 may be formed by polyethyleneterephthalate (PET), polycarbonate (PC), polymethylmethacrylate (PMMA), polyethylenenaphthalate (PEN), polyethersulfone (PES), cyclo olefin copolymer (COC), a triacetylcellulose (TAC) film, a polyvinyl alcohol (PVA) film, a polyimide (PI) film, polystyrene (PS), biaxially oriented polystrylene (BOPS, containing a K resin), glass or tempered glass, but is not particularly limited thereto.

Additionally, high-frequency processing or primer processing may be performed in order to activate the transparent substrate 100. As such, bonding force between the transparent substrate 100 and the electrode 200 may be improved by activating the transparent substrate 100.

The transparent substrate 100 may be a window provided at an outermost side of the touch panel. When the transparent substrate 100 is the window, the electrode 200 is directly formed on the window, and as a result, a process of forming the electrode 200 on the additional transparent substrate 100 and thereafter, attaching the formed electrode 200 to the window is omitted to simplify a manufacturing process and reduce the total thickness of the touch panel.

Hereinafter, a touch panel according to a second preferred embodiment of the present invention will be described with reference to the accompanying drawings.

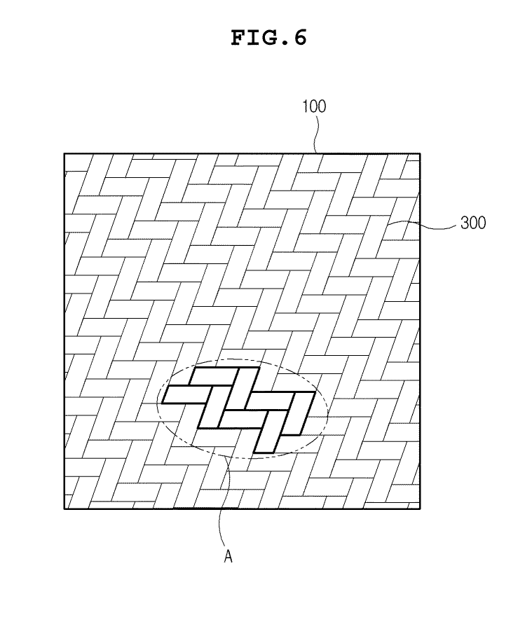

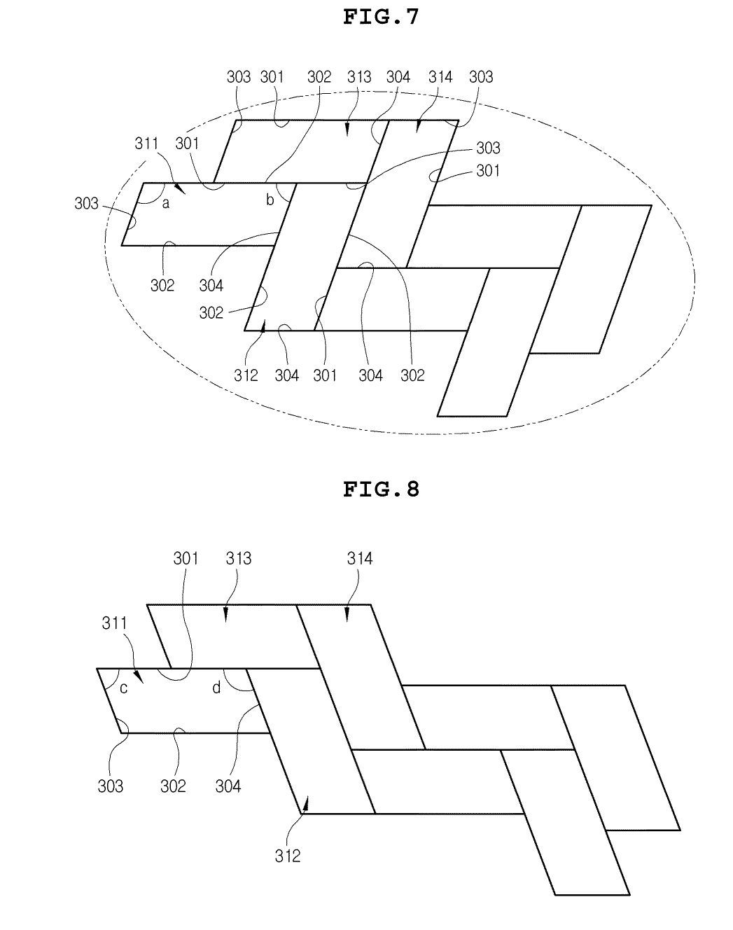

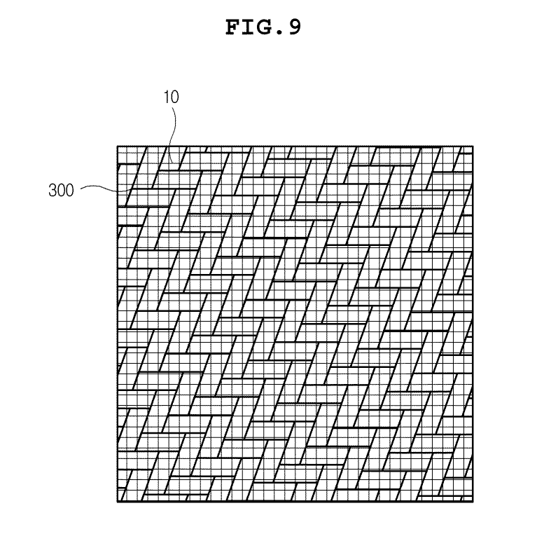

FIG. 6 is a plan view of a touch panel according to a second preferred embodiment of the present invention. FIG. 7 is an enlarged diagram acquired by enlarging area A illustrated in FIG. 6. FIG. 8 is an enlarged diagram illustrating another example of parallelograms illustrated in FIG. 7.

As illustrated in FIG. 6, the touch panel according to the preferred embodiment includes an electrode 300 formed in a pattern including parallelograms that are arranged while sharing sides.

The electrode 300 performs the same function as the electrode 200 (see FIG. 1) described in the first preferred embodiment. That is, the electrode 300 serving to allow a controller to recognize a touch coordinate by generating a signal when the electrode 200 is touched by a user may be formed on a transparent substrate 100.

The electrode 300 may be formed by copper (Cu), aluminum (Al), gold (Au), silver (Ag), titanium (Ti), palladium (Pd), chrome (Cr), or combinations thereof. In this case, the electrode 300 may be formed by a plating process or an evaporation process using a sputter. The electrode 300 may be formed by metallic silver formed by exposing/developing a silver salt emulsion layer in addition to the metal.

In the preferred embodiment, not the rectangle but the parallelograms are included in the pattern forming the electrode 300. The parallelogram includes for example, a first side 301 and a second side 302 which are parallel and a third side 303 and a fourth side 304 which are parallel like a first parallelogram 311 illustrated in FIG. 7, however, the first side 301 is longer than the third side 303. That is, a pair of sides 301 and 302 which are parallel are longer than the other pair of sides 303 and 304 which are parallel. In this case, a length ratio of a short side and a long side of the parallelogram may be for example, 1:2.

In the parallelogram, an angle a formed by the first side 301 and the third side 303 may be an obtuse angle as illustrated in FIG. 7. In this case, an angle b formed by the first side 301 and the fourth side 304 is an acute angle. Alternatively, in the parallelogram, an angle c formed by the first side 301 and the third side 303 may be the acute angle unlike described above. In this case, an angle d formed by the first side 301 and the fourth side 304 is the obtuse angle.

The parallelograms 311, 312, 313, and 314 are arranged while maintaining the same arrangement rule as the rectangles described in the first preferred embodiment. That is, as illustrated in FIG. 7, in the first parallelogram 311 and the second parallelogram 312, an angle formed by the first side 301 of the first rectangle 311 and the third side 303 of the second rectangle 312 is the straight angle. Therefore, the first side 301 of the first parallelogram 311 and the third side 303 of the second parallelogram 312 form the straight line that extends on the same line. An angle formed by the first side 301 of the third parallelogram 313 and the third side 303 of the fourth parallelogram 314 is also the straight angle. The first side 301 of the third parallelogram 313 and the third side 303 of the fourth parallelogram 314 also form the straight line that extends on the same line. In this case, the first side 301 of the second parallelogram 312 and the fourth side 304 of the third parallelogram 313 also form the straight angle. That is, the third parallelogram 313 is arranged while sharing the sides with the first parallelogram 311 and the second parallelogram 312 and in this case, the fourth side 304 of the third parallelogram 313 and the first side 301 of the second parallelogram 312 form the straight line that extends on the same line.

In the pattern of the electrode 300, another parallelograms having the same arrangement rule as the parallelograms 311, 312, 313, and 314 may be arranged continuously while sharing the sides with the parallelograms 311, 312, 313, and 314.

The pattern of the electrode 300 includes the parallelograms arranged as above, and as a result, the line which is continuous even in any direction is not formed. Accordingly, a periodic characteristic of the pattern of the electrode 300 is not overlapped with the periodic characteristic of the pattern of the black matrix 10 of the color filter like the first preferred embodiment, and as a result, the Moire phenomenon may be prevented from occurring in the touch panel.

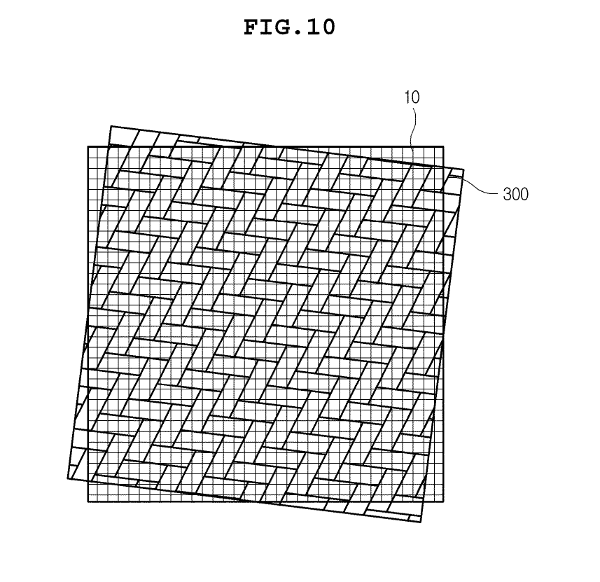

In more detail, referring to FIGS. 9 and 10, the case in which the Moire phenomenon does not occur will be described below.

FIGS. 9 and 10 are plan views illustrating a state in which the black matrix pattern of the color filter is overlapped with the electrode pattern of FIG. 6.

As illustrated in FIG. 9, the pattern of the electrode 300 does not have the line which is continuous even in any direction. On the contrary, the pattern of the black matrix 10 of the color filter provided in the image display device (LCD, and the like) has a line which is continuous in the horizontal and vertical directions while forming the periodic lattice structure. Accordingly, although the pattern of the electrode 300 and the pattern of the black matrix 10 are overlapped with each other, occurrence of an interference phenomenon may be minimized, and as a result, the Moire phenomenon may be prevented.

As illustrated in FIG. 10, although the patterns are rotated at a predetermined angle while the pattern of the electrode 300 and the pattern of the black matrix 10 are overlapped with each other, an interference phenomenon may also be minimized, and as a result, the Moire phenomenon may be prevented.

Moreover, since the pattern of the electrode 300 may maintain an aperture ratio per unit area of the pattern of the electrode 300, the touch panel may ensure electrical conductivity and visuality.

Meanwhile, the electrode 300 may be formed on the transparent substrate 100 (see FIG. 6) and since the transparent substrate 100 has been already described in detail in the description of the first preferred embodiment, the transparent substrate 100 will not be described in detail herein.

According to the preferred embodiments of the present invention, since the electrode pattern does not have the continuous line even in any direction, the Moire phenomenon can be prevented from occurring in the touch panel, and as a result, the visuality of the touch panel can be improved.

Since the rectangles or the parallelograms included in the electrode pattern have the regular arrangement rule, the aperture ratio per unit area of the electrode pattern can be constantly maintained, thereby ensuring uniform electrical conductivity and visuality of the touch panel.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
an electrode formed in a pattern including rectangles arranged while sharing sides,
wherein the rectangle includes a first side and a second side which are parallel and a third side and a fourth side which are parallel, the first side being longer than the third side, and
in the rectangles, among the rectangles, a first side of a first rectangle and a third side of a second rectangle form a straight angle, a first side of the third rectangle and a third side of a fourth rectangle form the straight angle, and a first side of the second rectangle and a fourth side of the third rectangle form the straight angle.

2. The touch panel as set forth in claim 1, wherein a length ratio of a short side and a long side of the rectangle is 1:2.

3. The touch panel as set forth in claim 1, further comprising:
a transparent substrate with the electrode formed thereon.

4. The touch panel as set forth in claim 1, wherein the electrode is formed by copper (Cu), aluminum (Al), gold (Au), silver (Ag), titanium (Ti), palladium (Pd), chrome (Cr), or combinations thereof.

5. The touch panel as set forth in claim 1, wherein the electrode is formed by metallic silver formed by exposing/developing a silver salt emulsion layer.

6. A touch panel, comprising:
an electrode formed in a pattern including parallelograms arranged while sharing sides,
wherein the parallelogram includes a first side and a second side which are parallel and a third side and a fourth side which are parallel, the first side being longer than the third side and the first side and the third side form an acute angle or an obtuse angle, and
in the parallelograms included in the pattern, among the parallelograms, a first side of a first parallelogram and a third side of a second parallelogram form a straight angle, a first side of the third parallelogram and a third side of a fourth parallelogram form the straight angle, and a first side of the second parallelogram and a fourth side of the third parallelogram form the straight angle.

7. The touch panel as set forth in claim 6, wherein a length ratio of a short side and a long side of the parallelogram is 1:2.

8. The touch panel as set forth in claim 6, further comprising:
a transparent substrate with the electrode formed thereon.

9. The touch panel as set forth in claim 6, wherein the electrode is formed by copper (Cu), aluminum (Al), gold (Au), silver (Ag), titanium (Ti), palladium (Pd), chrome (Cr), or combinations thereof.

10. The touch panel as set forth in claim 6, wherein the electrode is formed by metallic silver formed by exposing/developing a silver salt emulsion layer.
